(19) United States
(12) Patent Application Publication
(10) Pub. No.: US 2012/0163747 A1
(43) Pub. Date: Jun. 28, 2012

(54) Reduced Resistance Bearing

(76) Inventors: Martin N. Leibowitz, Hillsboro, FL (US); Charles M. Bell, Hillsboro, FL (US)

(21) Appl. No.: 12/978,057

(22) Filed: Dec. 23, 2010

(51) Int. Cl. F16C 33/38; F16C 19/06; F16C 33/44

(52) U.S. Cl. 384/530; 384/527

(57) ABSTRACT

A method and apparatus is disclosed whereby there is an improvement in the construction of the housing for the balls of a bearing. The benefit of this method of construction is that under certain loading forces, the ball cage, now termed a retaining disk, does not bind the balls. The retaining disk is designed with an elliptical hole that spaces the balls apart but allows them enough freedom to rotate without any binding.

More concisely, the ball bearing includes an inner race and an outer race with a plurality of bearing balls movably retained therebetween. A split retaining ring, having upper and lower annular rings, forms a plurality of bearing ball housings. These ball housings include a substantially spherical cavity which is elongated in an arc, or a short linear path, about a rotational center line of the ball bearing. The cavity has slightly flattened surfaces in a plane normal to the bearing plane (formed by the entire ball bearing) thereby permitting the balls to linearly move in the elongated cavities. The annular rings are mounted together by rivets or other mounting mechanism. In a further embodiment, the annular rings are radially spaced apart from the inboard edge of the inner race when the outer race is fixed and the inner race moves with respect to the fixed outer race. In another embodiment, the outboard edge of the annular rings are spaced from the inboard edge of the outer race when the outer race moves as compared with the fixed inner race. Therefore, dependent upon which race is fixed (stationary), an engineer would use one type of annular ring or retaining ring or the other type of ring.

The present invention relates to a reduced resistance bearing. Further, it relates to mechanisms and methods which utilize a new form of containment for the bearing balls in order to provide a system that will handle loading both from an outside force, not associated with radial or axial forces, as well as traditional radial and axial forces generated at the center of traditional bearings.

### BACKGROUND OF THE INVENTION

Ball bearings are well known to include bearing balls retained between inner and outer races. The present improvement relates to specially designed bearing balls housings.

The present innovation is an improvement of the prior inventions of the radial bearings. Most ball bearings rely on a “cage” to retain the balls and to keep them spaced so as not to create negative frictions. Currently, the cages are prone to creating a binding or a sliding situation when under certain stresses, most notably loading from centrifugal force, not internally generated forces, but the external force from the bearing being rotated around some center a discrete distance away from the center of the bearing. This binding and sliding causes the bearing to run inefficiently and significantly decreases the life span of the bearing.

### OBJECTS OF THE INVENTION

It is an object of the present invention to provide a reduced resistance ball bearing.

It is a further object of the present invention to provide a ball bearing which enhances motive force by permitting limited linear movement of the bearing ball within ball housings when the hearing is positioned normal to the ground plane.

### SUMMARY OF THE INVENTION

A method and apparatus is disclosed whereby there is an improvement in the construction of the housing for the balls of a bearing. The benefit of this method of construction is that wider certain loading forces, the ball cage, now termed a retaining disk, does not bind the balls. The retaining disk is designed with an elliptical hole that spaces the balls apart but allows them enough freedom to rotate without any binding.

More concisely, the ball bearing includes an inner race and an outer race with a plurality of bearing balls movably retained therebetween. A split retaining ring, having upper and lower annular rings, forms a plurality of bearing ball housings. These ball housings include a substantially spherical cavity which is elongated in an arc, or a short linear path, about a rotational center line of the ball bearing. The cavity has slightly flattened surfaces in a plane normal to the bearing plane (formed by the entire ball bearing) thereby permitting the balls to linearly move in the elongated cavities. The annular rings are mounted together by rivets or other mounting mechanism. In a further embodiment, the annular rings are radially spaced apart from the inboard edge of the inner race when the outer race is fixed and the inner race moves with respect to the fixed outer race. In another embodiment, the outboard edge of the annular rings are spaced from the inboard edge of the outer race when the outer race moves as compared with the fixed inner race. Therefore, dependent upon which race is fixed (stationary), an engineer would use one type of annular ring or retaining ring or the other type of ring.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates a cross-sectional view of a ball bearing and the bearing rotational centerline 2;

FIG. 2 diagrammatically illustrates a partial, cross sectional view of a ball bearing and the ball housing formed by blocks in the upper or lower retaining rings (annular rings);

FIG. 3 is a perspective view of the ball bearing;

FIG. 4 is a cross sectional view of the ball bearing when the outer race is stationary or fixed as compared with the movable inner race;

FIG. 5 diagrammatically illustrates the reduced resistance ball bearing and shows the small linear spaces between the bearing balls and the housing cavities formed by the ball housings in the retaining rings;

FIG. 6 diagrammatically illustrates a cross sectional view of the ball bearing with small annular spaces when the inner race is fixed (see indicia 5X) and the outer race rotates with respect to the fixed inner race;

FIG. 7 diagrammatically illustrates the ball bearing when the outer race is fixed (5X) and the inner race rotatably moves showing that the outboard edge of the annular ring is spaced from the inboard edge of the outer race;

FIG. 8a diagrammatically illustrates the bearing of FIG. 6 at rest and FIG. 8b diagrammatically illustrates the bearing of FIG. 6 during operation (inner race fixed); and

FIG. 9a diagrammatically illustrates the bearing of FIG. 7 at rest and FIG. 9b diagrammatically illustrates the bearing of FIG. 7 in operation (outer race fixed).

### DETAILED DESCRIPTION OF THE PREFERRED EMBODIMENTS

The present invention relates to a low resistance ball bearing. Similar numerals designate similar items throughout the figures.

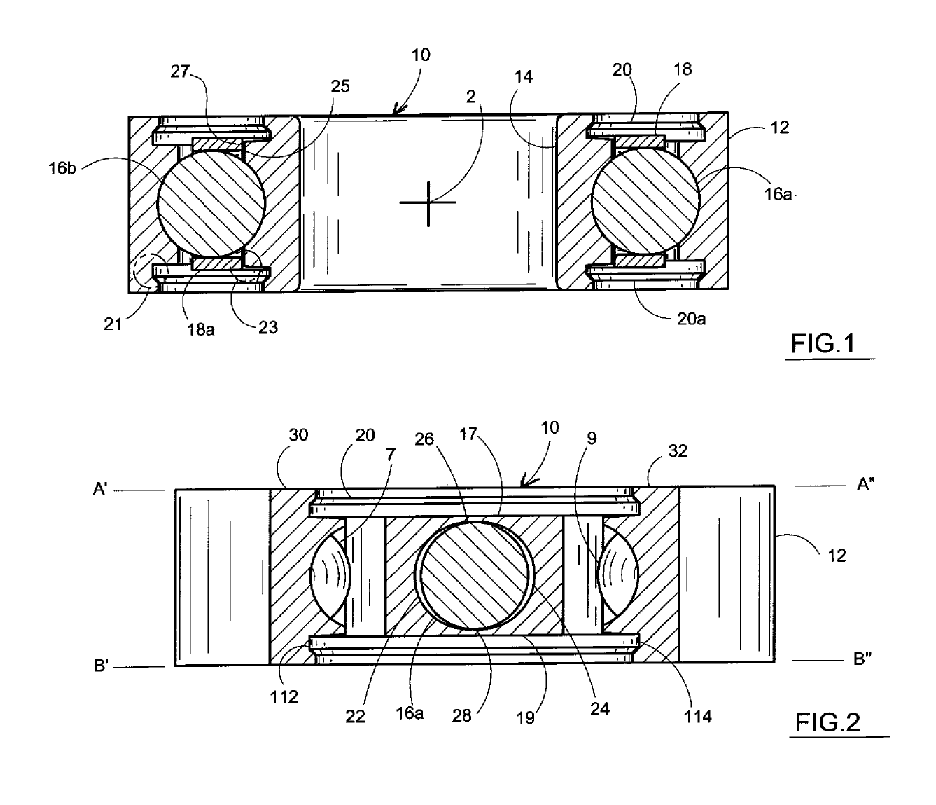

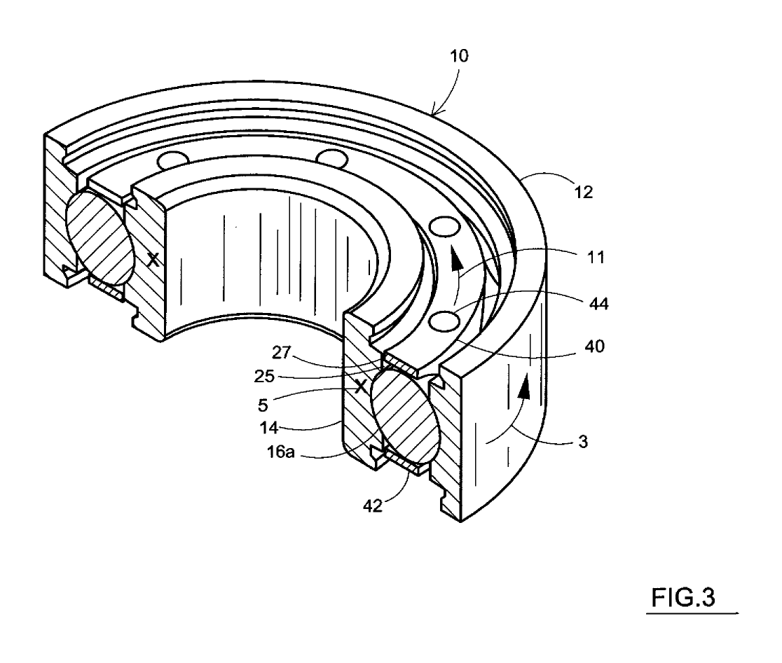

In general FIG. 1 is a partial view through the side of the bearing apparatus 10. Note that the outer race, the inner race, the balls, and the shields/seals are industry standard. The innovation is in the design of the retaining disk or annular ring 18, 18a. The retaining disk 18, 18a is comprised of two identical halves 18 and 18a that are riveted or otherwise fixed together. Several choices for material construction of the disk 18, 18a are Delrin, Nylon and Brass. The hole or cavity that retains the ball 16a is capsule-like in the profile view of FIG. 2. The hole is designed by taking a circle and pulling it apart horizontally thus creating a small flat area on the top and bottom of the said hole.

FIG. 2 is a cut view through the center of the bearing. There are grooves 112, 114 in the inner and outer race 14, 12 such that a shield or a seal 20 can be inserted to assist in maintaining proper lubrication from grease/oil. Regions 23 (FIG. 1) are the areas where the retaining disk 18, 18a may slide against the inner race 14. This is why the material for the retaining disk should have good lubricity.

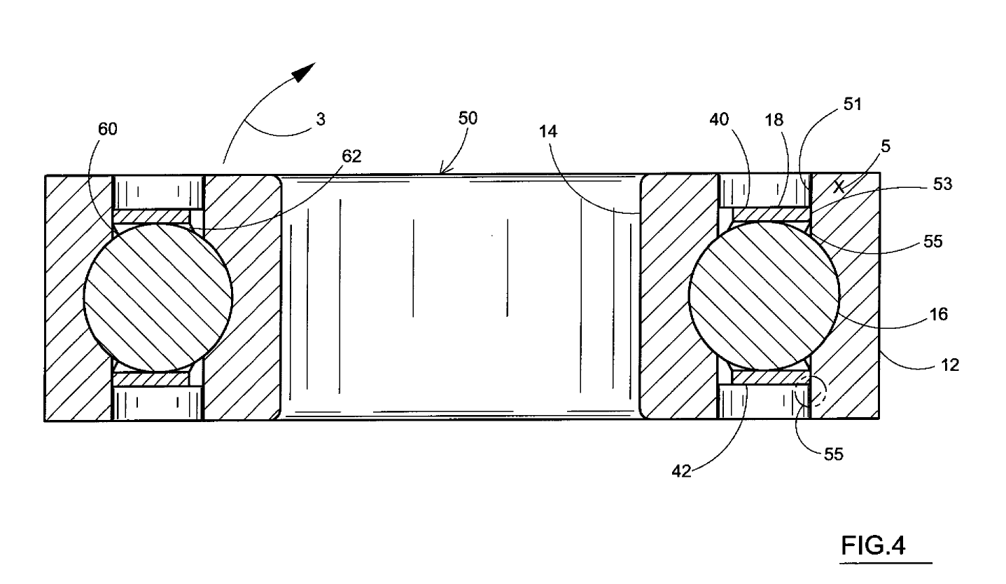

FIG. 3 is a three dimensional cut view of bearing 10. In this illustration, rivets 44 are shown. Note the arrows 3, 11 in all figures depict relative motion and the “5X” indicia represents fixed members which do not rotate. Furthermore, in this drawing, the retaining discs 18, 18a are riveted together but the method of joining them is not limited to rivets. Another method would be to have them snap or bolted or pinned together.

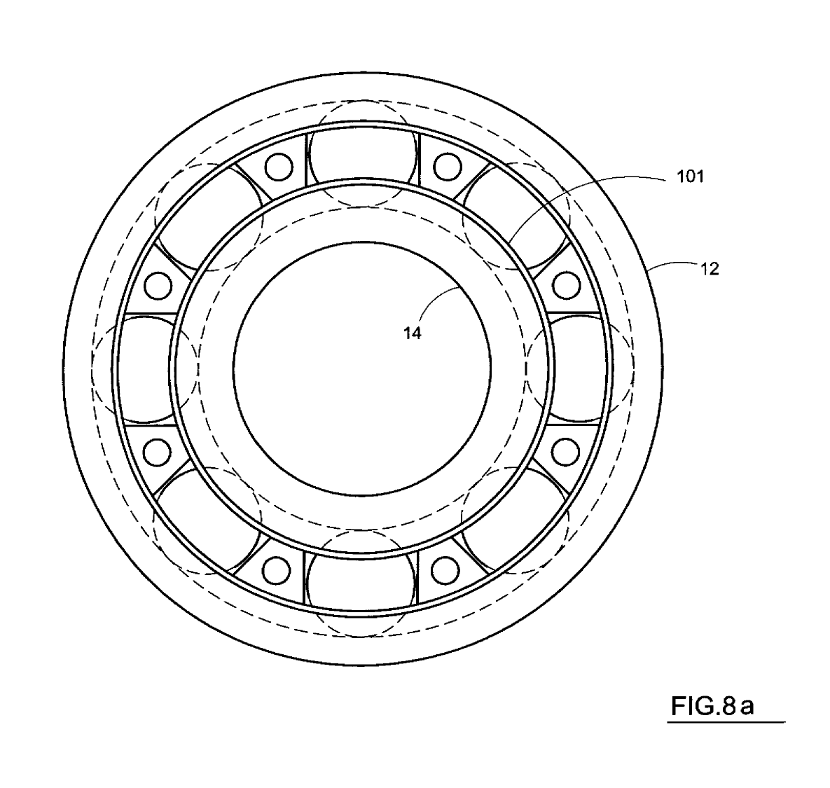

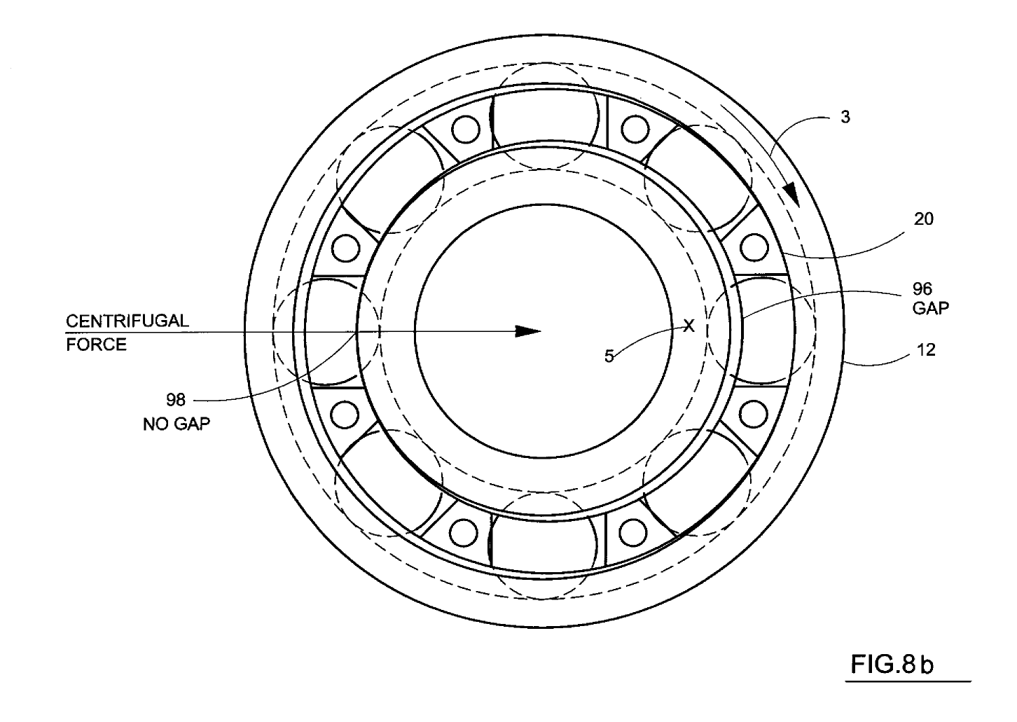

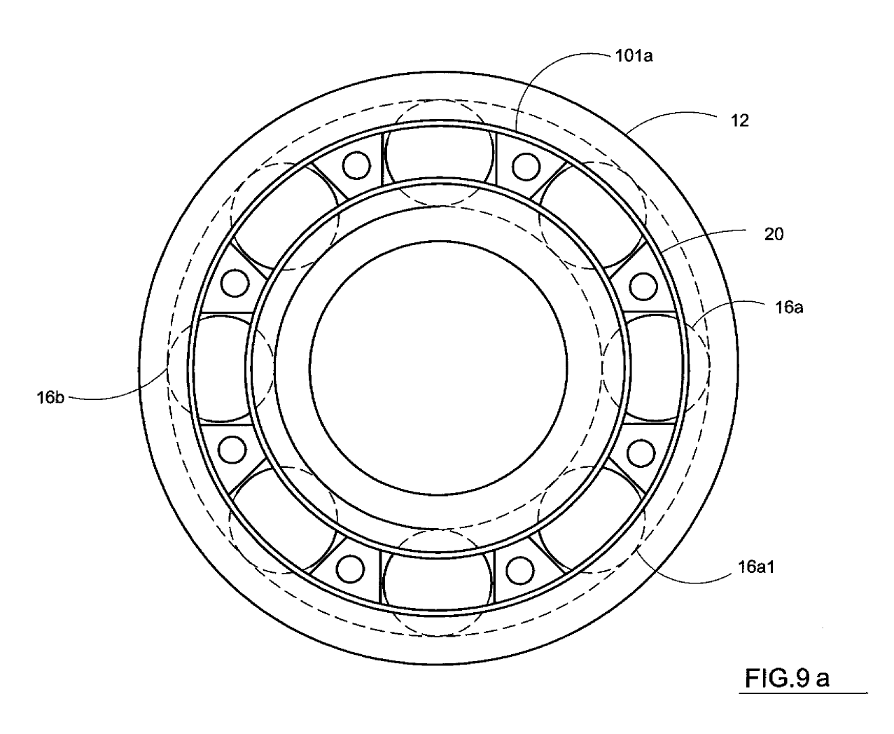

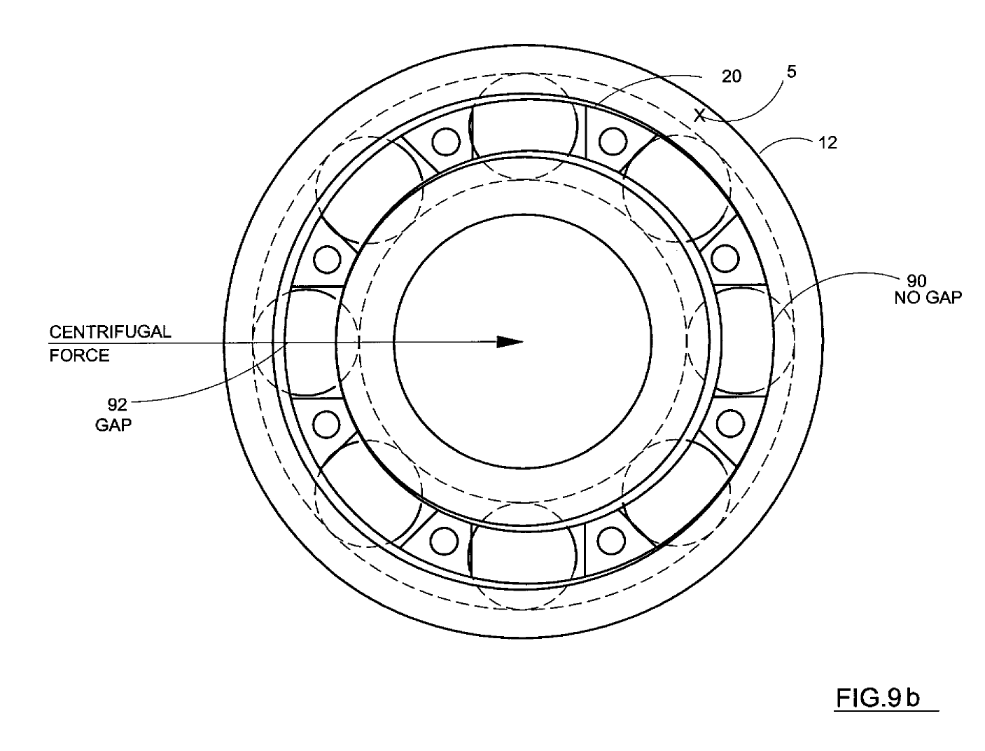

One important aspect of the bearing is whichever race rotates determines the type of retaining disk. For a bearing whose outer race is rotating while the inner race is fixed, the bearing construction is that as shown in FIGS. 6 and 8a, 8b. FIGS. 7, 9a and 9b illustrate the style of retainer needed when the inner race turns and the outer race is fixed/held stationary.

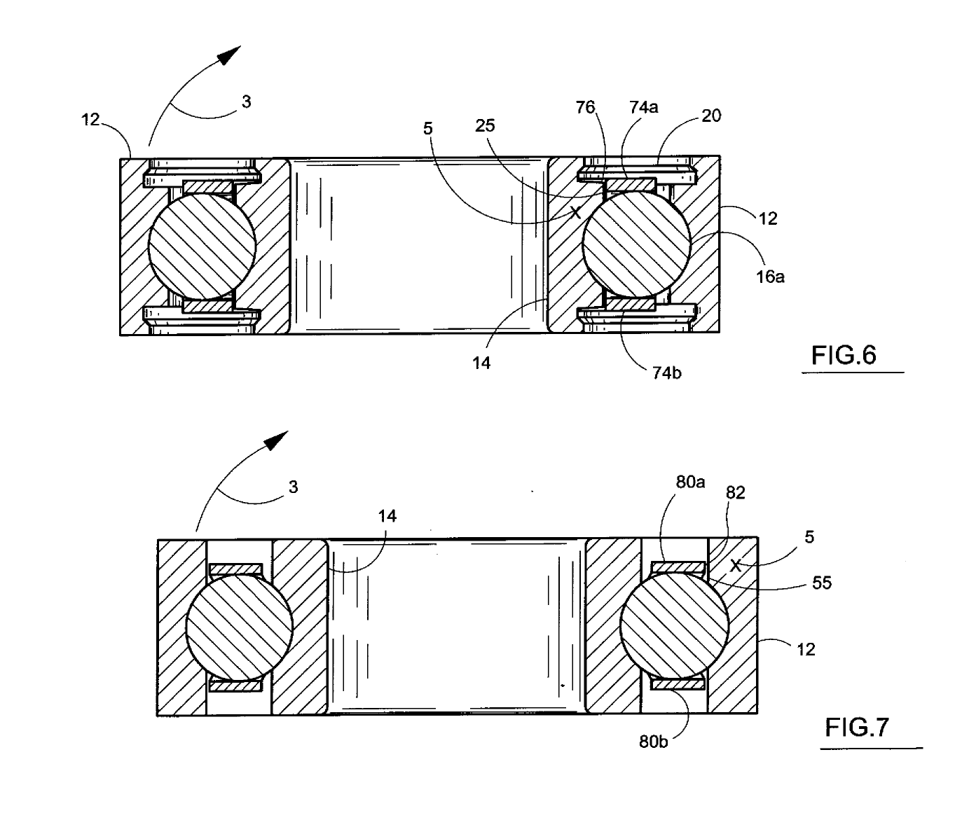

FIGS. 5, 8a, 8b, 9a and 9b are plane cut views down the center of bearing 10. As noted by arrows 3, 11 sometimes inner race 14 is rotating, and by the “5X” indicia, sometimes the outer race 12 stationary. The regions that allow sliding are between the outer race 12 and the retaining disk 80a in FIG. 7. The same shape for the ball cavity as described in FIG. 1 is also utilized with the bearings in FIGS. 6 and 7.

FIG. 5 is a simplified illustration of a top down view of bearing 10. The holes or spaces between ball 16a and housing walls 64, 66 are significantly wider than conventional bearings and are parallel. 5X defines the fixed portion of the bearing and the arrows 3, 11 define the direction of rotation.

FIG. 9b shows how the cage of bearing 10 is affected when under an external centrifugal force. The cage moves to the furthest point from the external center of rotation and slides against the outer race 12 that is stationary with respect to the rotating inner race 14, but never interferes with the rolling balls 16, 16a, thus decreasing the overall pressure felt by the bearing and reducing the resistance. This can be compared to a standard bearing in that the capsule like opening does not rub the balls all the way around nor in a circle but simply at one point.

FIG. 8b is a simplified illustration of a top down view of bearing 10. The holes between the ball and the housing are significantly wider than the ball 2 and are parallel. Again 5X defines the fixed portion of the bearing and the arrows 3, 11 define the direction of rotation.

FIG. 8b shows how the case of bearing 10 is affected when under an external centrifugal force. The cage moves to the furthest point from the external center of rotation and slides against the inner race 14 that is movable with respect to the fixed outer race 12, but never interferes with the rolling balls 16, 16a, thus decreasing the overall pressure felt by the bearing and reducing the resistance. This can also be compared to a standard bearing in that the capsule-like opening does not rub the balls all the way around nor in a circle but simply at one point.

A more specific description of the different embodiments follows. FIG. 1 diagrammatically illustrates ball bearing 10 which includes an outer race 12 and an inner race 14. A plurality of bearing balls 16a, 16b are retained between inner and outer races 14, 12. Further, these bearing balls are retained within a cavity formed by housing 18. The ball housings are formed as part of retaining rings 18, 18a. Shields or seals 20 and 20a seal the ends of bearing balls 16 and housings 18 and 18a. As noted in edge region 23, the inboard edge 27 of housing 18 abuts or is near or adjacent to outboard edge 25 of inner race 14. As noted in circle 21, the shield 20a permits insertion of oil or lubricant and seals the internal aspect of the bearing from external environmental issues.

FIG. 2 diagrammatically illustrates a partial, cross-sectional view of the bearing showing bearing ball 16a disposed in a cavity formed by ball housings 17 and 19. Ball housings 17 and 19 are substantially the same or are integral with the annular rings 18, 18a in FIG. 1. The cavity formed by housing elements 17, 19 define a substantially spherical cavity which is slightly elongated either in an arc or a short linear path at the same radial distance about the rotational center line 2 shown in FIG. 1. The substantially spherical cavity is elongated at end regions 22, 24 but the cavity closely fits bearing ball 16a at upper and lower points 26, 28. Further, at points 26, 28, the cavity forms slightly flatten surfaces in a plane normal to the bearing plane. The bearing plane is a plane formed by the bearing assembly 10. Therefore, the flat regions 26, 28 are parallel and are aligned and are disposed in the bearing plane A′-A″ and B′-B″. The flats are parallel to the plane. Therefore, ball 16a moves left and right in the slightly elongated or elliptical cavity from the perspective shown in FIG. 2.

FIG. 3 is a perspective view of the bearing 10 and shows that outer race 12 moves in the direction of arrow 3 while inner race 14 is fixed as shown by the 5X numerical indicia. Sometimes movement is shown by arrows 3, 11. The housings which form the substantially spherical cavities for the bearing balls 16a, 16b, are formed by angular rings 40, 42. In FIG. 1, the rings are 18, 18a. Annular ring 40 (FIG. 3) is the top annular ring whereas annular ring 42 is the bottom annular ring from the perspective of FIG. 3. The rings are mounted together by rivets 44 or other mounting mechanism such as pins, screws, bolts or other fixable items. In the embodiment shown in FIG. 3, annular ring 40 has an inboard edge 27 that is adjacent or abuts outboard edge 25 of inner race 14.

FIG. 3 shows a perspective view of the bearing of FIG. 1 wherein outer race 12 moves in the direction shown by arrows 3, 11 and inner race 14 is stationary as shown by 5X. The inboard edge of annular ring 40, that is, inboard edge 27, is adjacent or abuts outboard edge 25 of inner race 14.

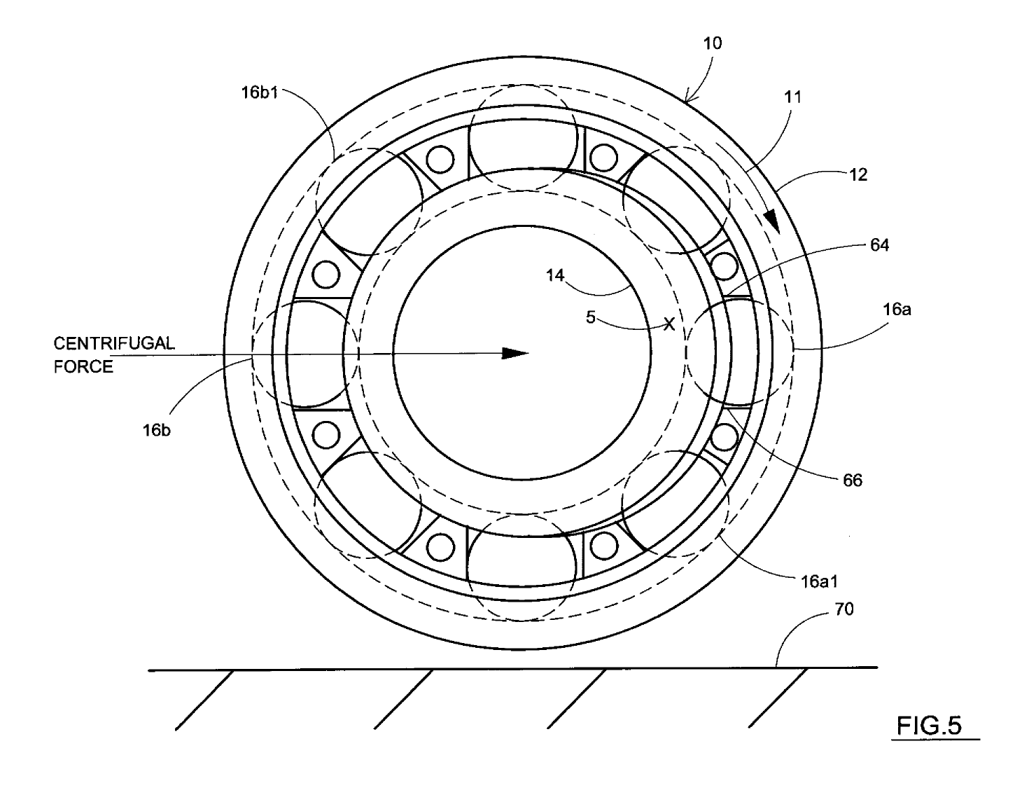

FIG. 4 diagrammatically illustrates a bearing 50 wherein outer race 12 is stationary as shown by 5X and inner race 14 rotates as shown by arrow 3. The ball bearing housing 18 formed by upper ring 40 and lower ring 42 has an outboard edge 53 which abuts or is closely adjacent to inboard edge or wall 55 of outer race 12. This close abatement is shown in circled area 55.

FIG. 5 diagrammatically illustrates the bearing of FIG. 1 and FIG. 3 wherein outer race 12 moves as shown by the arrow direction 11 and inner race 14 is stationary as shown by 5X. It should be noted that the balls, such as ball bearing 16a, are spaced apart as shown by spaces 64, 66 which note the small linear movement space in the substantially spherical cavity. Further, FIG. 5 shows that the bearing 10 is mounted normal to the ground plane 70. In this manner, when the bearing balls are in the lower hemisphere such as bearing ball 16a1, the leading edge of the bearing ball abuts the respective housing as compared with bearing ball 16b1 wherein the lagging edge or surface of the bearing ball abuts the opposite housing. In this manner, when the bearing balls rotate downward as compared with ground plane 70, the balls fall from an upper lagging position in the substantially spherical cavity to a lower leading position thereby imparting weight and additional force to the entire system.

FIG. 6 shows a different embodiment of the present invention wherein the outer race 12 rotates as noted by arrow 3 whereas the inner race 14 is fixed as shown by 5X. In this situation, the housing for the bearing balls 74a, 74b has an inboard edge 76 which is spaced apart from outboard edge or wall 25 of the inner race 14.

FIG. 7 shows the bearing wherein the outer race 12 is fixed as noted by 5X and the inner race rotates as noted by arrow 3. The annular rings form housing 80a, 80b, and has an outboard edge 52 which is spaced apart from wall 55 which is the inboard wall of the outer race 12.

FIG. 8a shows the bearing of FIG. 6 at rest. Bearing balls 16a, 16b and 16a1 are essentially positioned mid-point having small spaces between the substantially cylindrical elongated cavity. There is a small space 101 between the inboard edge of the annular rings for the housing and race 14.

In FIG. 8b, the system is in motion and outer race 12 rotates as noted by 5X whereas inner race 14 is fixed as shown by arrow 3. It should be noted that the annular ring shifts such that the annular ring touches the inner race 14 as noted at point 98 whereas a space exists at point 96 between the annular ring and the outboard edge of inner race 14.

FIG. 9a shows the at rest position of the bearing illustrated in FIG. 7. An equidistant space 101a is noted between the annular ring in the outboard edge of inner race 14.

In FIG. 9b, the bearing is in motion and inner race 14 moves as shown by directional arrow 3 whereas outer race 12 is stationary as noted by 5X. A space exists at point 92 between the outboard edge of the bearing housing and the inboard edge of outer race 14. In contrast, at point 90 there is no space between the annular ring of the bearing housing and the inner edge of the outer race 12.

While the invention has been described, disclosed, illustrated and shown in certain terms or certain embodiments or modifications which it has assumed in practice, the scope of the invention is not intended to be nor should it be deemed to be limited thereby and such other modifications or embodiments as may be suggested by the teachings herein are particularly reserved especially as they fall within the breadth and scope of the description and drawings.

The claims appended hereto are meant to cover modifications and changes within the scope and spirit of the present invention.

What is claimed is:

1. A ball bearing comprising:
an inner race and an outer race with a plurality of bearing balls movably retained between the inner and outer race adapted to permit the inner race to rotate with respect to the outer race about a rotational centerline and in a plane defined by said inner and outer race, said inner race being fixed and immobile;
a retaining ring in said bearing plane formed by a plurality of bearing ball housings, each bearing ball housing encasing a respective bearing ball and each housing defining a substantially spherical cavity encasing said bearing ball, said substantially spherical cavity being elongated in an arc about said rotational centerline and having slightly flattened surfaces in a plane normal to said bearing plane thereby permitting said bearing ball to linearly move in said elongated cavity, said retaining ring have a pair of annular rings coupled to said plurality of bearing ball housings on opposite sides of bearing ball housings, said annular rings and ball housings rotatably retained between said inner and outer race; and
said annular rings radially spaced apart from said inner race when said ball bearing is not rotating and said annular rings adapted to radially away from said rotational centerline due to said linear movement of said bearing balls in said housings when said outer race and said bearing balls and said annular rings are rotating with respect to said fixed inner race.

2. A ball bearing as claimed in claim 1 wherein said substantially spherical cavity is elliptically shaped about a radial arc of said rotational centerline.

3. A ball bearing as claimed in claim 1 wherein said housings are coupled via rivets or other coupling means to said annular rings.

4. A ball bearing as claimed in claim 1 wherein said housings are made of brass, DELRIN brand plastic or nylon.

5. A ball bearing comprising:
an inner race and an outer race with a plurality of bearing balls movably retained between the inner and outer race adapted to permit the inner race to rotate with respect to the outer race about a rotational centerline and in a plane defined by said inner and outer race, said outer race being fixed and immobile;
a retaining ring in said bearing plane formed by a plurality of bearing ball housings, each bearing ball housing encasing a respective bearing ball and each housing defining a substantially spherical cavity encasing said bearing ball, said substantially spherical cavity being elongated in an arc about said rotational centerline and having slightly flattened surfaces in a plane normal to said bearing plane thereby permitting said bearing ball to linearly move in said elongated cavity, said retaining ring have a pair of annular rings coupled to said plurality of bearing ball housings on opposite sides of bearing ball housings, said annular rings and ball housings rotatably retained between said inner and outer race; and
said annular rings radially spaced apart from said inner race when said ball bearing is not rotating and said annular rings adapted to radially away from said rotational centerline due to said linear movement of said bearing balls in said housings when said outer race and said bearing balls and said annular rings are rotating with respect to said fixed outer race.

6. A ball bearing as claimed in claim 5 wherein said substantially spherical cavity is elliptically shaped about a radial arc of said rotational centerline.

7. A ball bearing as claimed in claim 5 wherein said housings are coupled via rivets or other coupling means to said annular rings.

8. A ball bearing as claimed in claim 5 wherein said housings are made of brass, DELRIN brand plastic or nylon.

9. A ball bearing comprising:
an inner race and an outer race with a plurality of bearing balls movably retained between the inner and outer race adapted to permit the inner race to rotate with respect to the outer race about a rotational centerline and in a plane defined by said inner and outer race, said inner race being fixed and immobile;
a retaining ring in said bearing plane formed by a plurality of bearing ball housings, each bearing ball housing encasing a respective bearing ball and each housing defining a substantially spherical cavity encasing said bearing ball, said substantially spherical cavity being elongated in an arc about said rotational centerline and having slightly flattened surfaces in a plane normal to said bearing plane thereby permitting said bearing ball to linearly move in said elongated cavity, said retaining ring have a pair of annular rings coupled to said plurality of bearing ball housings on opposite sides of hearing ball housings, said annular rings and ball housings rotatably retained between said inner and outer race; and
said annular rings rotatably mounted adjacent said inner race thereby sliding thereon when said outer race and said hearing balls and said annular rings are rotating with respect to said fixed inner race.

10. A ball bearing as claimed in claim 9 wherein said substantially spherical cavity is elliptically shaped about a radial arc of said rotational centerline.

11. A ball bearing as claimed in claim 9 wherein said housings are coupled via rivets or other coupling means to said annular rings.

12. A ball bearing as claimed in claim 9 wherein said housings are made of brass, DELRIN brand plastic or nylon.

13. A ball bearing comprising:
an inner race and an outer race with a plurality of bearing balls movably retained between the inner and outer race adapted to permit the inner race to rotate with respect to the outer race about a rotational centerline and in a plane defined by said inner and outer race, said outer race being fixed and immobile;
a retaining ring in said bearing plane formed by a plurality of bearing ball housings, each bearing ball housing encasing a respective bearing ball and each housing defining a substantially spherical cavity encasing said bearing ball, said substantially spherical cavity being elongated in an arc about said rotational centerline and having slightly flattened surfaces in a plane normal to said bearing plane thereby permitting said bearing ball to linearly move in said elongated cavity, said retaining ring have a pair of annular rings coupled to said plurality of bearing ball housings on opposite sides of bearing ball housings, said annular rings and ball housings rotatably retained between said inner and outer race; and
said annular rings rotatably mounted adjacent said inner race thereby sliding thereon when said outer race and said bearing balls and said annular rings are rotating with respect to said fixed outer race.

14. A ball bearing as claimed in claim 13 wherein said substantially spherical cavity is elliptically shaped about a radial arc of said rotational centerline.

15. A ball bearing as claimed in claim 13 wherein said housings are coupled via rivets or other coupling means to said annular rings.

16. A ball bearing as claimed in claim 13 wherein said housings are made of brass, DELRIN brand plastic or nylon.
